(19) United States
(12) Patent Application Publication
(10) Pub. No.: US 2021/0207514 A1
(43) Pub. Date: Jul. 8, 2021

(54) EXHAUST GAS PURIFICATION APPARATUS

(71) Applicants: HYUNDAI MOTOR COMPANY, Seoul (KR); KIA MOTORS CORPORATION, Seoul (KR)

(72) Inventors: Hyokyung Lee, Anyang-si (KR); Chang Hwan Kim, Seongnam-si (KR); Jin Woo Choung, Suwon-si (KR)

(73) Assignees: HYUNDAI MOTOR COMPANY, Seoul (KR); KIA MOTORS CORPORATION, Seoul (KR)

(21) Appl. No.: 16/993,560

(22) Filed: Aug. 14, 2020

(30) Foreign Application Priority Data
Jan. 2, 2020 (KR) 10-2020-0000129

(51) Int. Cl. F01N 3/20; F01N 3/10; F01N 3/28

(52) U.S. Cl. CPC F01N 3/2066; F01N 3/103; F01N 3/2839; F01N 3/2807; F01N 2610/1453; F01N 2570/12; F01N 2570/14; F01N 2570/10; F01N 2610/02; F01N 2370/04

(57) ABSTRACT

An exhaust gas purification apparatus provided to purify the exhaust gas of an engine includes: an exhaust line through which exhaust gas discharged from the engine passes, a diesel oxidation catalyst (DOC) installed in the exhaust line to purify hydrocarbons (HC) and carbon monoxide (CO) in the exhaust gas, a urea injector for spraying a urea aqueous solution inside the exhaust line, and a selective catalyst reduction (SCR) for reducing nitrogen oxides (NOx) of exhaust gas that has passed through the DOC using the urea aqueous solution. In particular, the DOC includes a cerium-zirconium oxide (CeZrOx) catalyst.

### CROSS-REFERENCE TO RELATED APPLICATION

This application claims priority to and the benefit of Korean Patent Application No. 10-2020-0000129, filed on Jan. 2, 2020, the entire contents of which are incorporated herein by reference.

### FIELD

The present disclosure relates to an exhaust gas purification apparatus. More particularly, the present disclosure relates to an exhaust gas purification apparatus including a diesel oxidation catalyst.

### BACKGROUND

The statements in this section merely provide background information related to the present disclosure and may not constitute prior art.

In general, to reduce a pollution material contained in an exhaust gas such as carbon monoxide (CO), hydrocarbons (HC), nitrogen oxides (NOx), etc., an exhaust system of an engine includes an exhaust gas post-treatment device such as a diesel oxidation catalyst (DOC) device, a selective catalytic reduction (SCR) device, and a nitrogen oxide storage catalyst (Lean NOx Trap, LNT catalytic) device, etc.

The DOC can oxidize total hydrocarbons and carbon monoxide in exhaust gas and oxidize nitrogen monoxide to nitrogen dioxide.

In the SCR, the reducing agent (e.g., urea) injected in the stream direction of the exhaust gas through the injector is converted to ammonia (NH3) by the heat of the exhaust gas. Then, nitrogen oxide is reduced to nitrogen gas (N2) and water (H2O) through a catalytic reaction between nitrogen oxide and ammonia in the exhaust gas by the SCR catalyst.

In recent years, as the emission regulations of vehicles have been further strengthened, improvement of nitrogen oxide purification performance for the SCR system is desired. In particular, a technique for reducing nitrogen oxides in an inactive region of the SCR during cold start is desired.

To this end, a combination catalyst of palladium (Pd) and zeolite is applied to the diesel oxidation catalyst to store NOx in the exhaust gas when the SCR is in a low-temperature and a non-operating region, and desorb the stored NOx after the SCR is activated. So, it allows SCR to purify NOx.

However, we have discovered that, in this diesel oxidation catalyst, palladium that is ion-exchanged is precipitated and oxidized in an atmosphere having a high air-fuel ratio, thereby deteriorating the nitrogen oxide storage performance of the diesel oxidation catalyst. When driving a diesel vehicle, the exhaust gas is in a lean condition with a lot of oxygen, but instantaneous rich spikes may occur intermittently, and at this time, the diesel oxidation catalyst may deteriorate.

The above information disclosed in this Background section is only for enhancement of understanding of the background of the present disclosure, and therefore it may contain information that does not form the prior art that is already known to a person of ordinary skill in the art.

### SUMMARY

The present disclosure provides an exhaust gas purification apparatus capable of inhibiting catalyst deterioration by allowing the air-fuel ratio of the exhaust gas around the catalyst to be maintained at the theoretical air-fuel ratio when the air-fuel ratio of the exhaust gas becomes rich by mixing a material that can supply oxygen in the event of a momentary thick spike in a diesel oxidation catalyst.

In one form of the present disclosure, an exhaust gas purification apparatus provided to purify the exhaust gas of the engine includes: an exhaust line through which exhaust gas discharged from the engine passes, a diesel oxidation catalyst (DOC) installed in the exhaust line to purify hydrocarbons (HC) and carbon monoxide (CO) in the exhaust gas, a urea injector for spraying a urea aqueous solution inside the exhaust line, and a selective catalyst reduction (SCR) for reducing nitrogen oxides (NOx) of exhaust gas that has passed through the diesel oxidation catalyst using the urea aqueous solution. In particular, the DOC includes a cerium-zirconium oxide (CeZrOx) catalyst.

In one form, the DOC may include a palladium-containing zeolite (Pd/Zeolite) carrier.

In another form, the CeZrOx catalyst may be provided in the form of an island fixed to an outer surface of the diesel oxidation catalyst carrier.

In other form, the CeZrOx catalyst may be formed of a porous thin film surrounding an exterior of the diesel oxidation catalyst carrier.

In still other form, the DOC may store the NOx in the exhaust gas in an inactive region of the selective reduction catalyst, and desorb the stored NOx after the selective reduction catalyst is activated.

According to an exemplary form of the present disclosure, the atmosphere around the catalyst is maintained at a theoretical air-fuel ratio to prevent deterioration of the catalyst and to improve nitrogen oxide purification performance by mixing a material capable of supplying oxygen with a diesel oxidation catalyst when a momentary rich spike occurs during the driving of a diesel vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram schematically showing an exhaust gas purification apparatus according to an exemplary form of the present disclosure;

FIG. 2 is a view schematically showing a diesel oxidation catalyst according to an exemplary form of the present disclosure;

FIG. 3 is a view schematically showing a diesel oxidation catalyst according to another exemplary form of the present disclosure;

FIG. 4 is a graph showing a state in which an instantaneous rich spike occurs when driving a diesel vehicle;

FIG. 5 is a graph for selecting the amount of the cerium-zirconium oxide (CeZrOx) catalyst by calculating the oxygen deficiency when a rich spike occurs;

FIG. 6 is a table for calculating the oxygen deficiency according to the graph shown in FIG. 5; and

FIG. 7 is a graph showing an effect of improving nitrogen oxide removal performance using a diesel oxidation catalyst according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure.

Further, in exemplary forms, since like reference numerals designate like elements having the same configuration, a first exemplary form is representatively described, and in other exemplary forms, only configurations different from the first exemplary form will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. In addition, like structures, elements, or components illustrated in two or more drawings use same reference numerals for showing similar features. It will be understood that when an element such as a layer, film, region, or substrate is referred to as being “on” another element, it can be directly on the other element or intervening elements may also be present.

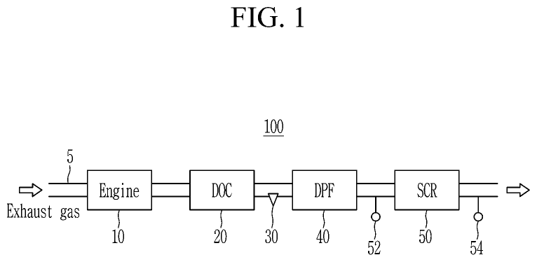

Now, an exhaust gas purification apparatus according to an exemplary form of the present disclosure will be described with reference to FIG. 1.

Referring to FIG. 1, the exhaust gas purification device 100 includes an exhaust line 5 connected to the engine 10 to purify the exhaust gas of the engine 10 and through which the exhaust gas discharged from the engine 10 passes, a diesel oxidation catalyst (DOC) 20, a urea injector 30, and a selective catalyst reduction (SCR) 50.

The DOC 20 is mounted on the exhaust line 5 formed to exhaust the exhaust gas of the engine 10. That is, the front end of the DOC 20 is connected to the engine 10 to receive exhaust gas discharged from the engine 10. Here, the front end and the rear end of the component are based on the flow of exhaust gas, and the exhaust gas is defined as flowing from the front end to the rear end of the component.

The DOC 20 may be provided with a carrier inside a predetermined case, and a diesel oxidation catalyst may be coated on the carrier. The DOC 20 is purified by oxidizing hydrocarbon (HC) and carbon monoxide (CO) in exhaust gas.

At the rear end of the DOC 20, a diesel particulate matter filter (DPF) 40 may be provided. The DPF 40 is formed with a catalyst carrier for collecting particulate matter contained in exhaust gas, thereby purifying particulate matter through a chemical conversion process. That is, the DPF 40 physically collects the particulate matter in the exhaust gas of the diesel engine 10 using a filter. Then, after driving a certain distance, the temperature of the exhaust gas is increased above the ignition temperature of the particulate matter (550° C.) to burn the particulate matter to reduce pollutants. A pressure sensor or a temperature sensor may be provided at the front end and the rear end of the DPF 40. In addition, the sensors sense the pressure and temperature before and after the exhaust gas passes through the DPF 40, and the electronic control unit (ECU) controls the engine 10 and related devices to remove accumulated particulate matter.

The DPF 40 may be coated with a catalyst that does not contain a noble metal (platinum (Pt), palladium (Pd), rhodium (Rh)). Since no noble metal is coated, it is possible to inhibit or prevent ammonia of the exhaust gas flowing into the DPF 40 from being oxidized.

In addition, the DPF 40 may be coated with a hydrolysis catalyst that hydrolyzes urea injected from the urea injector 30. The hydrolysis catalyst does not oxidize nitrogen and hydrolyzes the sprayed urea.

The SCR 50 may be provided at the rear end of the DPF 40, and nitrogen oxides of exhaust gas passing through the DOC 20 may be reduced using an urea aqueous solution. A reducing agent (e.g., urea) is converted to ammonia by the heat of the exhaust gas, and serves to reduce nitrogen oxides to nitrogen gas and water through a catalytic reaction between nitrogen oxides and ammonia in the exhaust gas while passing the SCR 50.

Nitrogen oxide sensors 52 and 54 are provided at the front end and the rear end of the SCR 50 to measure the amount of nitrogen oxide before and after the exhaust gas passes through the SCR 50.

Meanwhile, the DOC 20 may store nitrogen oxide (NOx) in the exhaust gas in an inactive region of the SCR 50 and desorb the stored NOx after the SCR 50 is activated.

The urea injector 30 is located at the rear end of the DOC 20 and injects an urea aqueous solution into the exhaust line 5. The urea injector 30 may spray urea or directly ammonia. In addition, other reducing agents other than ammonia may be injected with or with ammonia itself.

On the other hand, although not shown, a mixer may be installed in the exhaust line 5 at the rear end of the urea injector 30 to enable rapid flow diffusion of exhaust gas passing through the DOC 20. In addition, between the DPF 40 and the SCR 50, a low pressure exhaust gas regenerator pipe may be connected. Accordingly, the exhaust gas that has passed through the DPF 40 may be recirculated to the engine 10 through the exhaust gas regenerator.

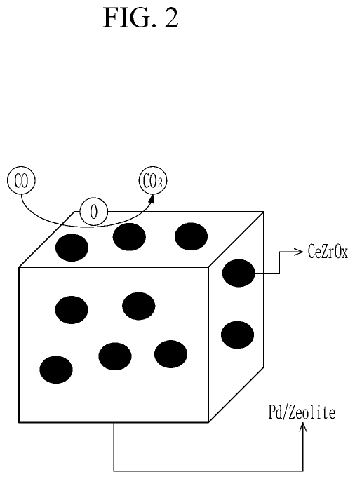

FIG. 2 is a view schematically showing a diesel oxidation catalyst according to an exemplary form of the present disclosure.

Referring to FIG. 2, the DOC 20 includes a cerium-zirconium oxide (CeZrOx) catalyst.

As shown in FIG. 2, the DOC 20 may include a palladium-containing zeolite (Pd/Zeolite) carrier. In addition, the cerium-zirconium oxide (CeZrOx) catalyst may be provided in the form of an island fixed to the outer surface of a DOC 20 carrier, that is, a palladium-containing zeolite (Pd/Zeolite) carrier. In a rich atmosphere, the cerium-zirconium oxide (CeZrOx) catalyst supplies oxygen molecules (O) to the surroundings, thereby maintaining the ambient atmosphere of the catalyst at a theoretical air-fuel ratio. That is, by the oxygen molecules supplied to the periphery, it is possible to inhibit or prevent the catalyst for removing nitrogen oxides from deteriorating by preventing the nitrogen oxide storage main agent palladium-containing zeolite (Pd/Zeolite) from being exposed to a rich atmosphere.

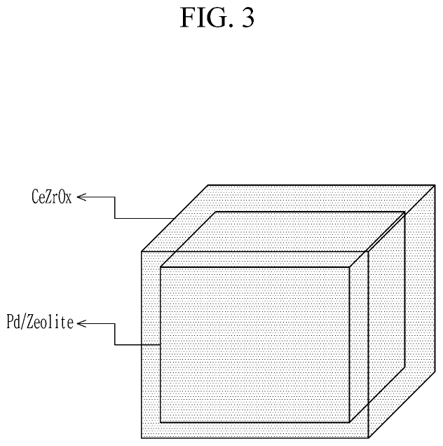

FIG. 3 is a view schematically showing a diesel oxidation catalyst according to another exemplary form of the present disclosure.

Referring to FIG. 3, the DOC 20 includes a cerium-zirconium oxide (CeZrOx) catalyst, the DOC includes a palladium-containing zeolite (Pd/Zeolite) carrier, and the cerium-zirconium oxide (CeZrOx) catalyst may be formed of a porous thin film surrounding the exterior of a palladium-containing zeolite (Pd/Zeolite) carrier.

The cerium-zirconium oxide (CeZrOx) catalyst is provided in a form coated with a porous thin film on the outer surface of the palladium-containing zeolite (Pd/Zeolite) carrier, thereby reducing or minimizing exposure of the palladium-containing zeolite (Pd/Zeolite) to a rich atmosphere.

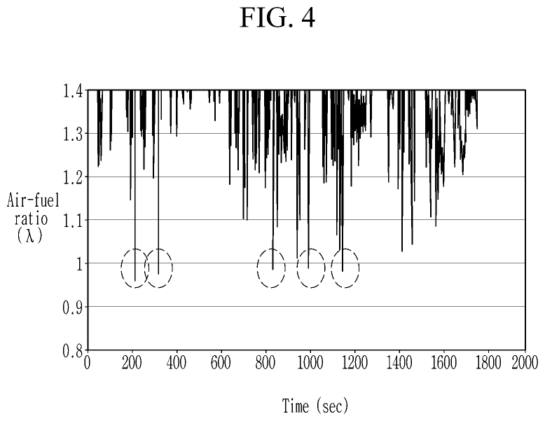

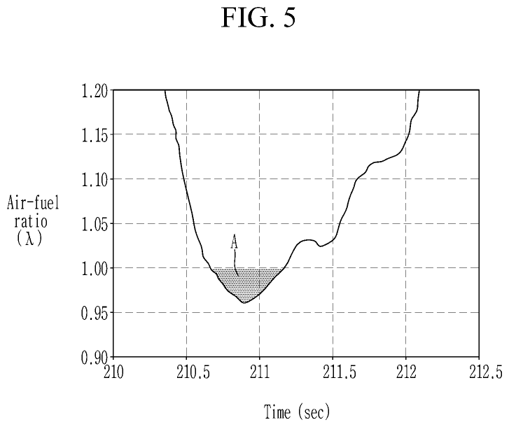

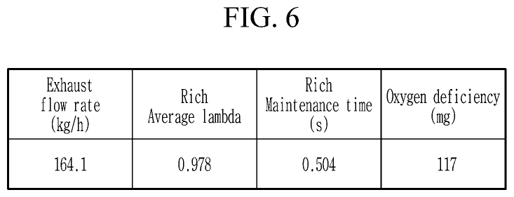

FIG. 4 is a graph showing a state in which an instantaneous rich spike occurs when driving a diesel vehicle, FIG. 5 is a graph for selecting the amount of the cerium-zirconium oxide (CeZrOx) catalyst by calculating the oxygen deficiency when a rich spike occurs, and FIG. 6 is a table for calculating the oxygen deficiency according to the graph shown in FIG. 5.

Referring to FIG. 4 to FIG. 6, while a diesel vehicle is driving, an instantaneous spike event may occur when the atmosphere around the catalyst is rich, that is, the air-fuel ratio λ is less than “1”. It is possible to derive the rich state maintenance time (s) and the rich air condition average air-fuel ratio (λ) during the occurrence of the thick spike through the graph. In addition, the exhaust flow rate (kg/h) of the exhaust gas can be measured through measurement elements such as an exhaust flow rate sensor. It is possible to derive the oxygen deficiency (mg) desired for the atmosphere around the catalyst to be the theoretical air-fuel ratio (λ=1) through the exhaust flow rate, the average rich air-fuel ratio (λ), and the rich state maintenance time (s). When the oxygen deficiency is derived, the amount of the cerium-zirconium oxide (CeZrOx) catalyst to be used may be derived.

The oxygen deficiency can be derived by Equation 1 below:

Oxygen deficiency (mg)=(1−rich state average air-fuel ratio(λ))×rich state maintenance time (s)×exhaust flow rate (mg/s)×0.23 [Equation 1]

At this time, 0.23 means the mass fraction of oxygen in the air.

In addition, the amount of the cerium-zirconium oxide (CeZrOx) catalyst to be used can be determined after measuring the oxygen storage capacity for each of the prepared cerium-zirconium oxide (CeZrOx) catalysts when an oxygen deficiency is derived according to the above method. The produced cerium-zirconium oxide (CeZrOx) catalyst has different oxygen emissions depending on the amount of the noble metal, so the amount of the cerium-zirconium oxide (CeZrOx) catalyst to be used can be experimentally determined from the oxygen deficiency.

For example, as shown in FIGS. 5 and 6, when the exhaust flow rate of the exhaust gas is around 164.1 kg/h, the average air-fuel ratio (λ) of the rich state is approximately 0.978, and the time (s) of the rich state maintenance is around 0.504 seconds, it can be derived that the oxygen deficiency amount is approximately 117 mg. In addition, the amount of the cerium-zirconium oxide (CeZrOx) catalyst to be used may be determined according to an experimentally derived value from the oxygen deficiency.

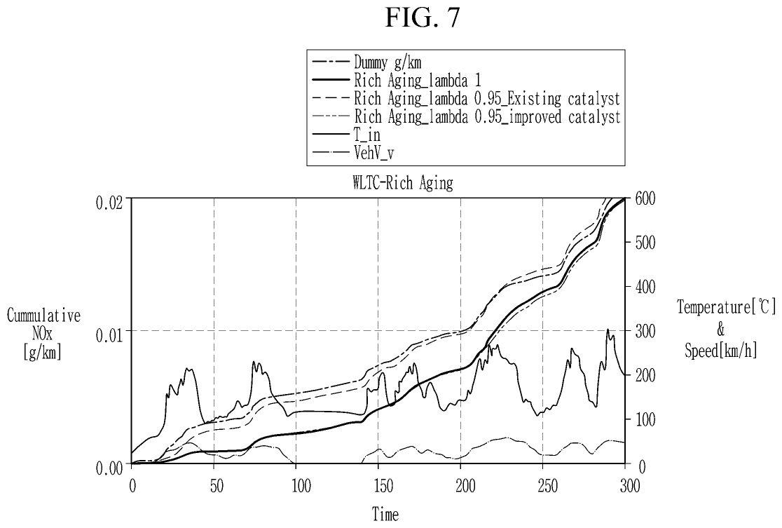

FIG. 7 is a graph showing an effect of improving nitrogen oxide removal performance using a diesel oxidation catalyst according to an exemplary form of the present disclosure.

Referring to FIG. 7, nitrogen oxides accumulated during the driving of diesel vehicles gradually increase, and when an existing catalyst is used in a rich state with an air-fuel ratio (λ) of 0.95, nitrogen oxides are about 0.01 g/km in about 200 seconds. In contrast, when using the improved catalyst according to an form of the present disclosure, nitrogen oxide is about 0.0075 g/km at about 200 seconds.

When the improved catalyst is used, it can be confirmed that even when the air-fuel ratio (λ) is 0.95 during the driving period, the amount of nitrogen oxides almost similar to the theoretical air-fuel ratio is detected. As such, by maintaining the atmosphere around the catalyst in a state similar to the theoretical air-fuel ratio by supplying oxygen of the cerium-zirconium oxide (CeZrOx) catalyst employed in the form of the present disclosure, the catalyst is prevented from deteriorating and the performance of purifying nitrogen oxides is improved.

Like this, according to an exemplary form of the present disclosure, the atmosphere around the catalyst is maintained at a theoretical air-fuel ratio to inhibit deterioration of the catalyst and to improve nitrogen oxide purification performance by mixing a material capable of supplying oxygen with a diesel oxidation catalyst when a momentary rich spike occurs during the driving of a diesel vehicle.

While this present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the present disclosure.

<Description of symbols>

| | |
|---|---|
| 100: exhaust gas purification | 5: exhaust line |
| apparatus | |
| 10: engine | 20: diesel oxidation catalyst |
| 30: urea injector | 40: diesel particulate matter filter |
| 50: selective catalyst reduction | 52, 54: nitrogen oxide sensor |

What is claimed is:

1. An exhaust gas purification apparatus for an engine, comprising:
an exhaust line through which exhaust gas discharged from the engine passes;
a diesel oxidation catalyst (DOC) installed in the exhaust line and configured to purify hydrocarbons (HC) and carbon monoxide (CO) in the exhaust gas;
a urea injector configured to spray a urea aqueous solution inside the exhaust line; and
a selective catalyst reduction (SCR) configured to reduce nitrogen oxides (NOx) in the exhaust gas that has passed through the DOC using the urea aqueous solution, and
the DOC includes a cerium-zirconium oxide (CeZrOx) catalyst.

2. The exhaust gas purification apparatus of claim 1, wherein:
the DOC includes a palladium-containing zeolite (Pd/Zeolite) carrier.

3. The exhaust gas purification apparatus of claim 1, wherein:
the CeZrOx catalyst is provided in the form of an island fixed to an outer surface of a DOC carrier.

4. The exhaust gas purification apparatus of claim 1, wherein:
the CeZrOx catalyst is formed of a porous thin film surrounding an exterior of an DOC carrier.

5. The exhaust gas purification apparatus of claim 1, wherein:
the DOC is configured to store the NOx in the exhaust gas in an inactive region of the SCR, and desorb the stored NOx after the SCR is activated.
